(19) United States
(12) Patent Application Publication
(10) Pub. No.: US 2024/0120146 A1
(43) Pub. Date: Apr. 11, 2024

(54) INDUCTOR-INTEGRATED TRANSFORMER

(71) Applicant: LG INNOTEK CO., LTD., Seoul (KR)

(72) Inventors: Jai Hoon Yeom, Seoul (KR); Sang Won Lee, Seoul (KR); Soo Kwang Yoon, Seoul (KR); Jong Sun Jeong, Seoul (KR)

(21) Appl. No.: 18/263,075

(22) PCT Filed: Jan. 28, 2022
(86) PCT No.: PCT/KR2022/001613

§ 371 Date: Jul. 26, 2023

(30) Foreign Application Priority Data
Feb. 3, 2021 (KR) 10-2021-0015204
Feb. 3, 2021 (KR) 10-2021-0015205

(51) Int. Cl. H01F 27/29; H01F 27/25

(52) U.S. Cl. CPC H01F 27/292; H01F 27/25

(57) ABSTRACT

An inductor-integrated transformer as an embodiment of the present invention includes a transformer core including an upper core and a lower core; a transformer coil including a primary coil and a secondary coil; an inductor core including an upper core and a lower core; and an inductor coil, wherein the primary coil includes a plurality of input terminals spaced a first distance apart from a first surface of the transformer core; and a plurality of input terminals spaced a second distance apart from a second surface, and the output terminal is electrically connected to the secondary coil and the inductor coil, and the first distance is greater than the second distance.

### TECHNICAL FIELD

The present disclosure relates to a transformer having an inductor integrated therewith.

### BACKGROUND ART

Recently, in order to improve driving efficiency of electric vehicles [xEV: a generic term for hybrid electric vehicles (HEVs), plug-in hybrid electric vehicles (PHEVs), electric vehicle (EVs), and the like], research on technology for system efficiency improvement, densification, and weight reduction of core modules, such as a DC-to-DC converter, an OBC, and an inverter, have been increasingly conducted. In particular, a compact structure and high efficiency are as important to large vehicle makers as price competitiveness. In order to realize a module having high performance characteristics in a confined space, high-density/high-performance design of a main magnetic part applied to the module needs to be performed.

An electric vehicle is generally equipped with both a high-voltage battery for driving an electric motor and an auxiliary battery for supplying power to an electronic load, and the auxiliary battery may be recharged by power of the high-voltage battery.

In this case, in order to recharge the auxiliary battery, it is necessary to convert the DC power of the high-voltage battery into DC power corresponding to the voltage of the auxiliary battery through voltage drop. To this end, a DC-to-DC converter is used.

In general, the DC-to-DC converter is disposed between the high-voltage battery and the auxiliary battery, and includes a driving circuit, a transformer, and an output circuit.

The DC-to-DC converter may include, in addition to the above components, a back-up unit in preparation for an emergency, and the back-up unit is a back-up power supply unit that operates in an emergency, for example, when the main DC-to-DC converter suddenly stops operating, in order to maintain essential functions for driving a vehicle.

The back-up unit, which functions as an auxiliary unit in preparation for an emergency, is a power conversion device that is driven at very low power (e.g. 150 W) compared to the main DC-to-DC converter, which is driven at a maximum of 3 kW.

Since the purpose of the back-up unit is to ensure minimum required operation of a system while controlling operation efficiency and heat generation temperature of parts, it is very important to verify conditions related to operation of protection circuits. In particular, it is essential to meet requirements for under-voltage protection (UVP: operation of interrupting supply of power to a main circuit in the event of voltage drop or loss), which is greatly influenced by the characteristics of a transformer, and over-current protection (OCP: a lower-level concept that complements OPP, which monitors outputs of all output channels of a power supply in real time, to protect a system by blocking flow of current exceeding an allowable level, OCP being independently implemented in each of the output channels of the power supply), which is greatly influenced by the characteristics of an inductor.

The transformer and the inductor used in the back-up unit use Mn—Zn ferrite material, but have low saturation magnetic flux densities. Thus, allowable current is relatively low for a given size. The reason for this is that the UVP depends on the inductance value of the transformer and the OCP absolutely depends on the inductance value of the inductor.

In order to solve this problem, UVP and OCP performance may be improved through an air gap between the transformer and the inductor. However, because initial inductance values decrease, the efficiency of the transformer is reduced, and there is a limitation on management of the inductance of the inductor.

### DISCLOSURE

### Technical Problem

It is an object of the present disclosure to solve at least one of the above problems.

The present disclosure provides an inductor-integrated transformer for use in a back-up unit, which is capable of effectively reducing UVP and increasing OCP while still maintaining a compact overall size.

### Technical Solution

An inductor-integrated transformer according to an embodiment of the present disclosure includes a transformer core including an upper core and a lower core, a transformer coil including a primary coil and a secondary coil, which are disposed inside the transformer core, an inductor core disposed on the transformer core, the inductor core including an upper core and a lower core, and an inductor coil disposed inside the inductor core, wherein the primary coil includes a plurality of input terminals spaced apart from a first surface of the transformer core by a first distance (Y) and a plurality of input terminals spaced apart from a second surface of the transformer core by a second distance (X), the second surface being a surface opposite the first surface, wherein the output terminals are conductively connected to the secondary coil and the inductor coil, and wherein the first distance (Y) is longer than the second distance (X).

In at least one embodiment of the present disclosure, the first distance (Y) and the second distance (X) have one of the following relationships: (a) the first distance (Y) being greater than or equal to 1.2 times the second distance (X), (b) the first distance (Y) being less than or equal to 1.5 times the second distance (X), and (c) the first distance (Y) being within a range of 1.2 times to 1.5 times the second distance (X).

In addition, in at least one embodiment of the present disclosure, the transformer core includes a first center leg, and the primary coil includes a coil portion formed so as to surround the first center leg, a first extended portion extending from the coil portion to an exterior of the first surface, the first extended portion having a plurality of input terminal holes formed therein corresponding to the plurality of input terminals, and a second extended portion extending from the coil portion to an exterior of the second surface, the second extended portion having a plurality of output terminal holes formed therein corresponding to the plurality of output terminals. Each of the input terminals includes an input-side pin inserted into a corresponding one of the input terminal holes, and each of the output terminals includes an output-side pin inserted into a corresponding one of the output terminal holes.

In addition, in at least one embodiment of the present disclosure, the first extended portion includes a protruding portion protruding therefrom in a direction intersecting the direction in which the first extended portion extends from the coil portion, and at least one of the plurality of input terminal holes is disposed in the protruding portion.

In addition, in at least one embodiment of the present disclosure, the inductor core includes a second center leg, and the inductor coil includes a wound portion wound so as to surround the second center leg and a terminal connection portion extending from one end of the wound portion to be connected to the output terminals. A shortest distance (L) from the wound portion to the output terminals and a line width (M) of the wound portion of the inductor coil have one of the following relationships: (a) the shortest distance (L) being greater than or equal to 0.4 times the line width (M), (b) the shortest distance (L) being less than or equal to 0.6 times the line width (M), and (c) the shortest distance (L) being within a range of 0.4 times to 0.6 times the line width (M).

In addition, in at least one embodiment of the present disclosure, the primary coil includes an upper primary coil and a lower primary coil, which are vertically spaced apart from each other, and the secondary coil is located between the upper primary coil and the lower primary coil.

In addition, in at least one embodiment of the present disclosure, each of the secondary coil and the inductor coil is formed by winding a flat wire.

In at least one embodiment of the present disclosure, at least one of the upper primary coil and the lower primary coil is a printed circuit board (PCB).

In addition, in at least one embodiment of the present disclosure, the upper primary coil and the lower primary coil have shapes corresponding to each other.

An inductor-integrated transformer according to another embodiment of the present disclosure includes a transformer and an inductor stacked on the transformer.

The transformer includes a primary coil, a secondary coil, and a transformer core providing a path through which lines of magnetic force emitted from one side of each of the primary and secondary coils diverge in opposite directions and return to the opposite side of each of the coils.

In addition, the inductor includes an inductor coil and an inductor core providing a path through which lines of magnetic force emitted from one side of the inductor coil diverge in opposite directions and return to the opposite side of the inductor coil.

Here, the outer surface of each of the transformer core and the inductor core is surrounded by a metal ribbon having a higher saturation magnetic flux density than a corresponding core in order to expand the path for lines of magnetic force.

In at least another embodiment of the present disclosure, the metal ribbon includes a first metal ribbon surrounding the transformer core and a second metal ribbon surrounding the inductor core.

In addition, in at least another embodiment of the present disclosure, the metal ribbon surrounds each core in three layers or more.

In at least another embodiment of the present disclosure, the material of the metal ribbon is an amorphous metal (preferably, Fe—Si—B or Fe—Si—Cu—Nb—B).

In at least another embodiment of the present disclosure, each of the transformer core and the inductor core has an opening formed in each of a front surface and a rear surface thereof. The primary coil is electrically connected to an input unit through the opening formed in the front surface of the transformer, the secondary coil is electrically connected to an output unit through the opening formed in the rear surface of the transformer, and the inductor coil is electrically connected to the output unit through the opening formed in the rear surface of the inductor core.

In addition, in at least another embodiment of the present disclosure, the metal ribbon surrounds an outer surface formed between the front surface and the rear surface of the transformer and/or the inductor core.

In addition, preferably, the metal ribbon completely surrounds the outer surface.

### Advantageous Effects

According to the present disclosure, a high-density inductor-integrated transformer for use in a back-up unit, which has a compact structure and is capable of reducing UVP and increasing OCP, may be obtained.

The effects achievable through the present disclosure are not limited to the above-mentioned effects, and other effects not mentioned herein will be clearly understood by those skilled in the art from the following description.

### DESCRIPTION OF DRAWINGS

FIG. 1 is a plan view of an inductor-integrated transformer according to an embodiment of the present disclosure.

FIG. 2 is a front view of the transformer shown in FIG. 1.

FIG. 3 is a rear view of the transformer shown in FIG. 1.

FIG. 4 is an electric circuit diagram of the transformer shown in FIG. 1.

FIG. 5 is a view of the transformer shown in FIG. 1, with an upper inductor and an upper core of a transformer core removed therefrom.

FIG. 6 is a view of the transformer shown in FIG. 1, with an upper core of an inductor core removed therefrom.

FIG. 7 is an exploded perspective view of the inductor-integrated transformer shown in FIG. 1.

FIG. 8 is a perspective view showing a state in which the transformer shown in FIG. 1 is equipped with metal ribbons.

FIG. 9 is a graph showing saturation magnetic flux densities of amorphous metal and ferrite.

FIG. 10 is a graph showing comparison of change in inductance of a transformer between after and before application of the metal ribbons to the inductor-integrated transformer shown in FIG. 8.

FIG. 11 is a graph showing comparison of change in inductance of an inductor between after and before application of the metal ribbons to the inductor-integrated transformer shown in FIG. 8.

FIG. 12 is a graph showing change in permeability according to the number of layers of each metal ribbon.

FIG. 13 is a graph showing change in permeability according to an application range of each metal ribbon.

### BEST MODE

The present disclosure will now be described more fully hereinafter with reference to the accompanying drawings, in which various embodiments are shown. The examples, however, may be embodied in many different forms and should not be construed as being limited to the embodiments set forth herein. It is to be understood that the present disclosure covers all modifications, equivalents, and alternatives falling within the scope and spirit of the present disclosure.

The suffixes “module” and “unit” used herein to describe configuration components are assigned or used in consideration only of convenience in creating this specification, and the two suffixes themselves do not have any distinguishable meanings or roles from a physicochemical point of view.

While ordinal numbers including “first”, “second”, etc. may be used to describe various components, they are not intended to limit the components. These expressions are used only to distinguish one component from another component.

As used herein, the term “and/or” includes any and all combinations of one or more of the associated listed items. For example, the phrase “A and/or B” means “(A), (B), or (A and B)”.

It will be understood that when an element is referred to as being “connected” or “coupled” to another element, it can be directly connected or coupled to the other element, or intervening elements may be present.

In the description of the embodiments, it will be understood that when an element, such as a layer (film), a region, a pattern or a structure, is referred to as being “on” or “under” another element, such as a substrate, a layer (film), a region, a pad or a pattern, the term “on” or “under” means that the element is directly on or under another element or is formed such that an intervening element may also be present. In addition, it will also be understood that criteria of “on” or “under” is on the basis of the drawing for convenience unless otherwise defined due to the characteristics of each of components or the relationship therebetween. The term “on” or “under” is used only to indicate the relative positional relationship between components and should not be construed as limiting the actual positions of the components. For example, the phrase “B on A” merely indicates that B is illustrated in the drawing as being located on A, unless otherwise defined or unless A must be located on B due to the characteristics of A or B. In an actual product, B may be located under A, or B and A may be disposed in a leftward-rightward direction.

In addition, the thickness or size of a layer (film), a region, a pattern, or a structure shown in the drawings may be exaggerated, omitted or schematically drawn for the clarity and convenience of explanation, and may not accurately reflect the actual size.

The terminology used herein is for the purpose of describing particular embodiments only and is not intended to be limiting of exemplary embodiments of the disclosure. As used herein, the singular forms are intended to include the plural forms as well, unless the context clearly indicates otherwise. It will be further understood that the terms “include” or “have”, when used herein, specify the presence of stated features, integers, steps, operations, elements, components, or combinations thereof, but do not preclude the presence or addition of one or more other features, integers, steps, operations, elements, components, or combinations thereof.

Unless otherwise defined, all terms used herein, which include technical or scientific terms, have the same meanings as those generally appreciated by those skilled in the art. The terms, such as ones defined in common dictionaries, should be interpreted as having the same meanings as terms in the context of pertinent technology, and should not be interpreted as having ideal or excessively formal meanings unless clearly defined in the specification.

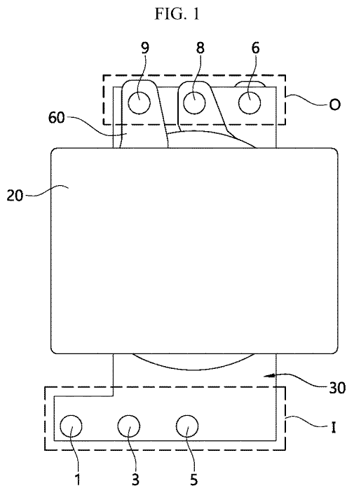

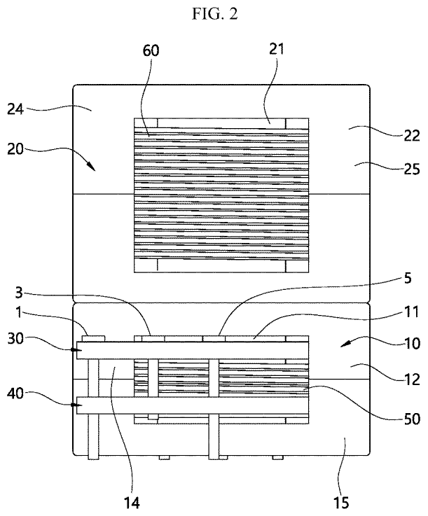

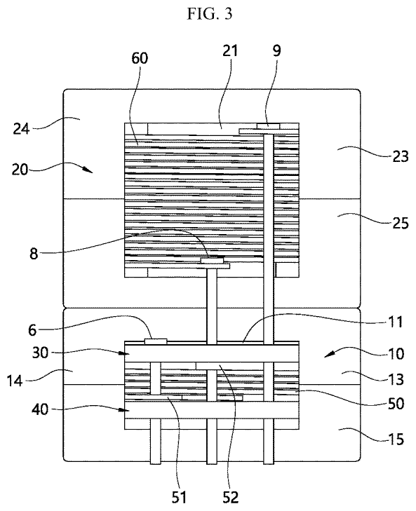

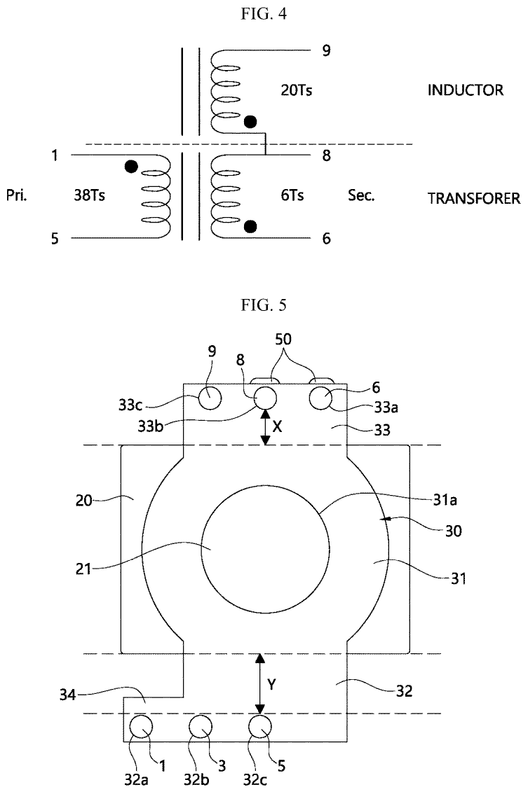

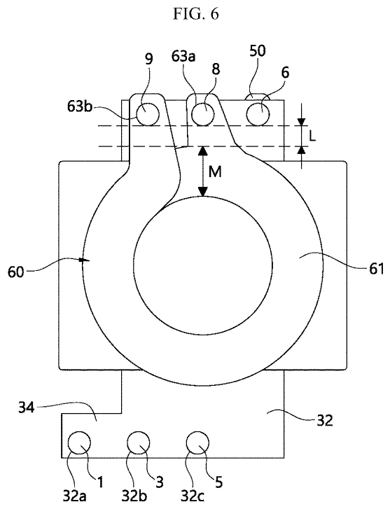

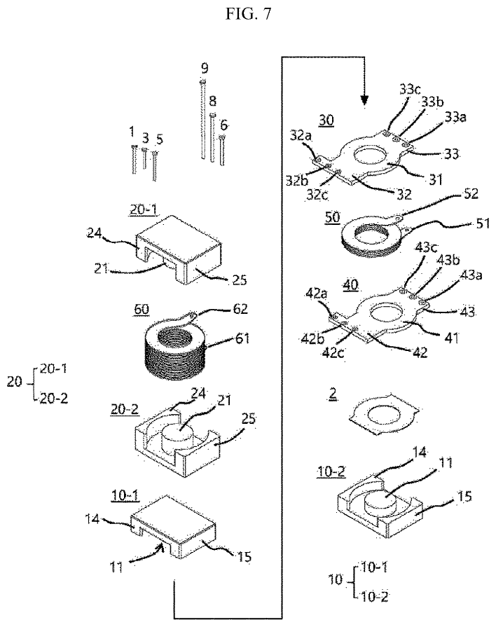

First, FIG. 1 is a plan view of an inductor-integrated transformer (excluding a metal ribbon) according to an embodiment of the present disclosure, FIG. 2 is a front view of the transformer shown in FIG. 1, FIG. 3 is a rear view of the transformer shown in FIG. 1, FIG. 4 is an electric circuit diagram of the transformer shown in FIG. 1, FIG. 5 is a view of the transformer shown in FIG. 1, with an upper inductor and an upper core of a transformer core 10 removed therefrom, FIG. 6 is a view of the transformer shown in FIG. 1, with an upper core of an inductor core 20 removed therefrom, and FIG. 7 is an exploded perspective view of the inductor-integrated transformer shown in FIG. 1.

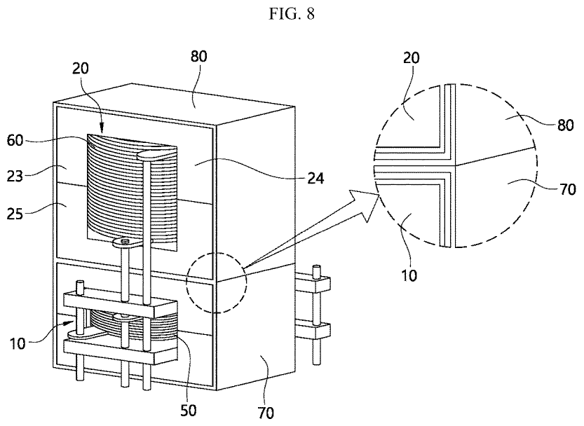

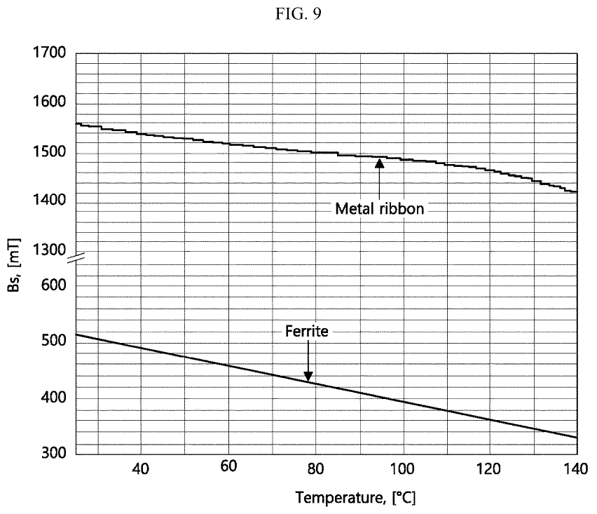

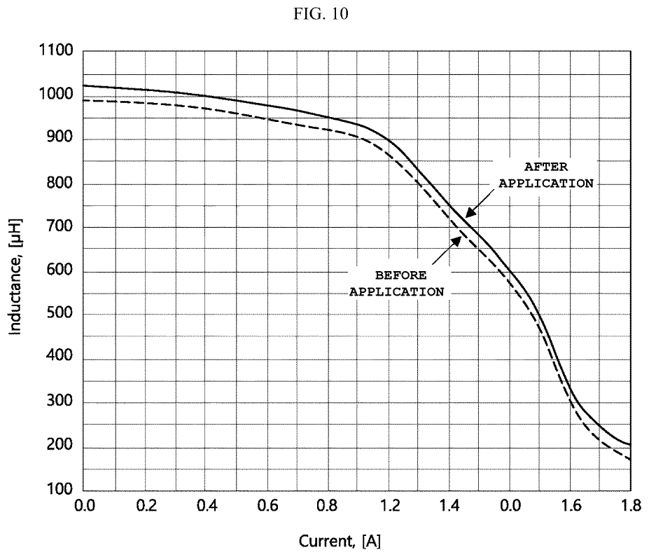

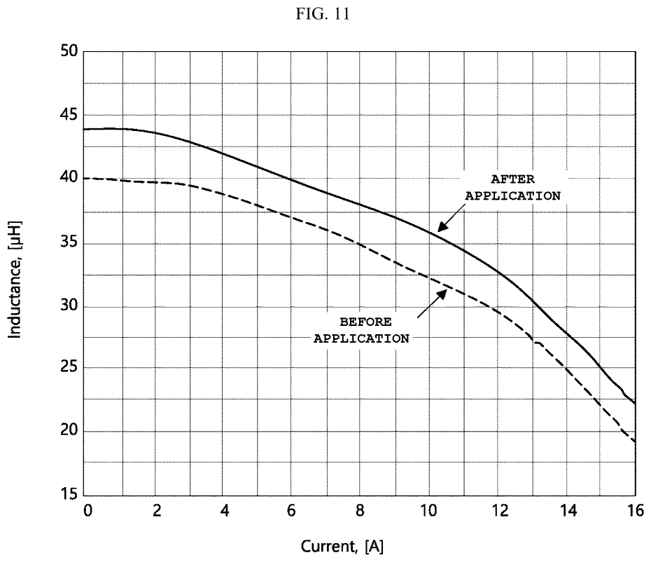

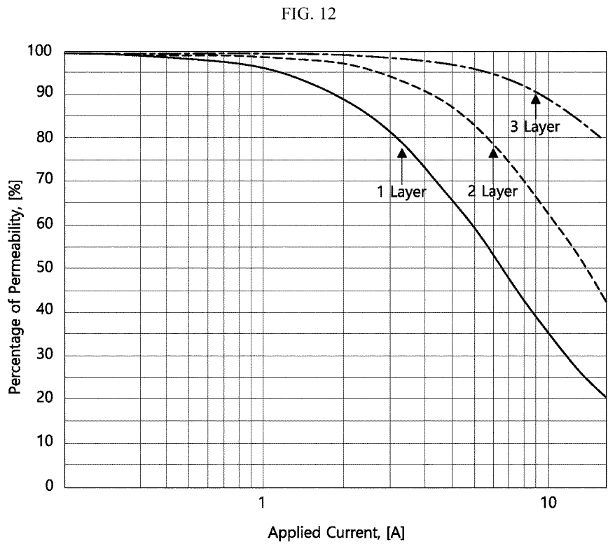

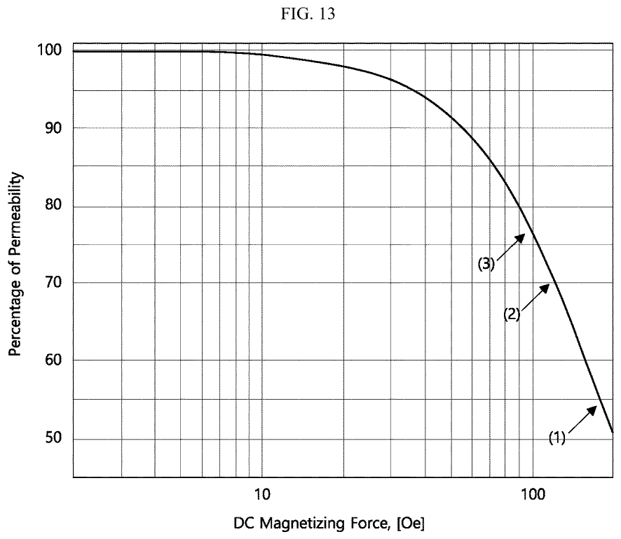

In addition, FIG. 8 is a perspective view showing a state in which the transformer shown in FIG. 1 is equipped with metal ribbons, FIG. 9 is a graph showing saturation magnetic flux densities of amorphous metal and ferrite, FIG. 10 is a graph showing comparison of change in inductance of the transformer between after and before application of the metal ribbons to the inductor-integrated transformer shown in FIG. 8, FIG. 11 is a graph showing comparison of change in inductance of the inductor between after and before application of the metal ribbons to the inductor-integrated transformer shown in FIG. 8, FIG. 12 is a graph showing change in permeability according to the number of layers of each metal ribbon, and FIG. 13 is a graph showing change in permeability according to the area of each metal ribbon.

The overall configuration of the inductor-integrated transformer will be described with reference to FIGS. 1 to 7.

The inductor-integrated transformer is configured such that a transformer is disposed at a lower position and an inductor is disposed at an upper position.

The transformer disposed at a lower position includes a transformer core 10, and the transformer core 10 is generally structured such that an upper core 10-1 and a lower core 10-2 are in contact with each other. Each of the upper core 10-1 and the lower core 10-2 includes outer legs 14 and 15 respectively formed on left and right ends thereof and a first center leg 11 formed between the pair of outer legs 14 and 15. The upper core 10-1 and the lower core 10-2 are symmetrical with each other with respect to a contact surface therebetween. Since this structure of the core is well known, further detailed description thereof will be omitted.

The transformer core 10 has an opening formed in each of a front surface 12 and a rear surface 13 thereof. Primary coils 30 and 40 are electrically connected to an input unit I through the opening in the front surface 12, and a secondary coil 50 is electrically connected to an output unit O through the opening in the rear surface 13.

The transformer core 10 provides a path through which lines of magnetic force emitted from one side of each of the primary coils 30 and 40 and the secondary coil 50 diverge in opposite directions and return to the opposite side of each of the coils.

In the embodiment, the primary coils of the transformer are implemented as PCB-type coils, and the secondary coil 50 of the transformer is implemented as a coil formed by winding a flat wire in a helical shape.

In the embodiment, a first PCB 30 and a second PCB 40 are used as PCBs for the primary coils.

The first PCB 30 includes a coil portion 31 formed at a center portion thereof, and includes a first extended portion 32 and a second extended portion 33, which integrally extend from the coil portion 31 in a forward direction and a backward direction.

As shown in FIG. 5, in the first PCB 30, the coil portion 31 has a center hole 31a formed therein, and includes a conductive pattern (not shown), which is plated with metal and is spirally wound about the center hole 31a so as to form a predetermined number of turns. The conductive pattern may be formed on each of an upper surface and a lower surface of the coil portion 31. The inner end of the spiral conductive pattern on each surface in a radial direction may pass through the PCB and may be electrically connected thereto.

The center hole 31a in the coil portion 31 is positively coupled to the first center leg 11 of the transformer, and this positive coupling enables concentric positioning of the conductive pattern with respect to the first center leg 11.

The first extended portion 32, which integrally extends from the coil portion 31, is provided on the front side of the coil portion 31 (the lower side in FIG. 5), and the second extended portion 33, which integrally extends from the coil portion 31, is provided on the rear side of the coil portion 31 (the upper side in FIG. 5).

The first extended portion 32 has a plurality of input terminal holes 32a and 32c formed therein, and the second extended portion 33 has a plurality of output terminal holes 33a, 33b, and 33c formed therein. Referring to FIG. 5, a first input terminal hole 32a and a second input terminal hole 32c are formed in the first extended portion 32, and a first output terminal hole 33a, a second output terminal hole 33b, and a third output terminal hole 33c are formed in the second extended portion 33. Referring to FIG. 5, a first connection pin hole 32b to be described later is formed between the first input terminal hole 32a and the second input terminal hole 32c.

In the embodiment, input terminals are formed in a pin type to constitute the input unit I. The input terminals include a first input-side pin 1, which is inserted through the first input terminal hole 32a, and a second input-side pin 5, which is inserted through the second input terminal hole 32c.

In addition, similarly, output terminals are also formed in a pin type to constitute the output unit O. The output terminals include a first output-side pin 6, which is inserted through the first output terminal hole 33a, a second output-side pin 8, which is inserted through the second output terminal hole 33b, and a third output-side pin 9, which is inserted through the third output terminal hole 33c.

Here, although not shown, electrical connection between the input terminals and the conductive spiral pattern may be achieved through a predetermined conductive pattern.

The first extended portion 32 includes a protruding portion 34 protruding therefrom in a direction (a leftward direction in FIG. 5) intersecting the direction in which the first extended portion 32 extends from the coil portion 31.

Further, the first input terminal hole 32a is formed in the protruding portion 34.

In the first PCB 30, the first input terminal hole 32a is connected to the spiral conductive pattern on the upper surface of the coil portion 31 via a predetermined conductive pattern, the inner end of the spiral pattern on the upper surface in the radial direction passes through the PCB and is electrically connected to the other spiral pattern formed on the lower surface of the coil portion 31, and the outer end of the spiral pattern on the lower surface in the radial direction is electrically connected to the first connection pin hole 32b via a predetermined conductive pattern.

The second PCB 40 has the same external shape as the first PCB 30. That is, a coil portion 41 having formed therein a center hole is provided, and extended portions 42 and 43 are formed on both sides of the coil portion 41 in the forward-backward direction. The extended portions have formed therein third and fourth input terminal holes 42a and 42c, which respectively correspond to the first input terminal hole 32a and the second input terminal hole 32c, a second connection pin hole 42b, which corresponds to the first connection pin hole 32b, and fourth, fifth, and sixth output terminal holes 43a, 43b, and 43c, which correspond to the first output terminal hole 33a, the second output terminal hole 33b, and the third output terminal hole 33c.

Spiral conductive patterns are also provided on both surfaces of the coil portion 31 of the second PCB 40. The conductive spiral pattern on the upper surface of the second PCB is electrically connected to the second connection pin hole 42b via a predetermined conductive pattern, the inner end of the spiral pattern in the radial direction passes through the PCB and is electrically connected to the inner end of the spiral pattern on the lower surface in the radial direction, and the outer end of the spiral pattern on the lower surface in the radial direction is electrically connected to the fourth input terminal hole 42c via a predetermined conductive pattern.

When the second PCB 40 is seated on the lower core of the inductor core, a support plate 2 is interposed therebetween to support the second PCB 40. The support plate 2 has a center portion having the same shape as the coil portion 41 of the second PCB 40, and has extended portions extending from the center portion by a length equal to about half the length of each of the extended portions 42 and 43 of the second PCB 40. The support plate 2 prevents the extended portions 42 and 43 from being bent and damaged when the second PCB 40 is pressed downwards.

As shown in FIG. 2, in the state in which the first PCB 30 and the second PCB 40 are disposed in a vertical direction, the first input-side pin 1 passes through the first input terminal hole 32a and the third input terminal hole 42a, and the second input-side pin 5 passes through the second input terminal hole 32c and the fourth input terminal hole 42c.

A connection pin 3 is inserted through the first connection pin hole 32b and the second connection pin hole 42b, whereby the conductive spiral pattern of the first PCB 30 and the conductive spiral pattern of the second PCB 40 are electrically connected to each other to form the primary coil.

The secondary coil 50 is implemented by winding a flat wire in a helical shape about the first center leg 11, and is disposed between the first PCB 30 and the second PCB 40.

Both ends of the secondary coil 50 are connected to the output terminals. To this end, as shown in FIG. 3, the first output-side pin 6, which passes through the first output terminal hole 33a and the fourth output terminal hole 43a, passes through a lower end portion 51 of the secondary coil 50 so as to be electrically connected thereto, and a second output-side pin 8, which passes through the second output terminal hole 33b and the fifth output terminal hole 43b, passes through an upper end portion 52 of the secondary coil 50 so as to be electrically connected thereto.

Meanwhile, the inductor is integrally formed with the transformer so as to be mounted thereon, and includes an inductor core 20 and an inductor coil 60.

The inductor core 20 is stacked on the transformer core 10. The shape and the structure of the inductor core 20 are identical to those of the transformer core 10, but the height of the inductor core 20 is higher than that of the transformer core 10. That is, the inductor core 20 has the same dimensions as the transformer core on the basis of the plan view of FIG. 1, except for the height.

Further, the inductor core is made of the same material as the transformer core 10. In the embodiment, a Mn—Zn-based ferrite core is used.

The inductor core 20 is also structured such that an upper core 20-1 and a lower core 20-2 are in contact with each other, and each of the upper core 20-1 and the lower core 20-2 includes a pair of outer legs 24 and 25 and a second center leg 21 formed therebetween. In FIGS. 2 and 3, reference numerals “22” and “23” denote a “front surface” and a “rear surface”, respectively.

The inductor core 20 has an opening formed in each of the front surface 22 and the rear surface 23 thereof, and the inductor coil 60 is electrically connected to the output unit O through the opening in the front surface 22.

The inductor core 20 provides a path through which lines of magnetic force emitted from one side of the inductor coil 60 diverge in opposite directions and return to the opposite side of the inductor coil 60.

The inductor coil 60 is implemented as a flat wire so as to have a shape and a structure approximately identical to those of the secondary coil 50, except for the number of turns of helical winding and a resultant height. The inductor coil 60 has a structure of being wound in a helical shape about the second center leg 21.

That is, referring to FIG. 6, the inductor coil 60 includes a wound portion 61, which is wound about the second center leg 21, and terminal connection portions 61 and 62, which extend from one end of the wound portion 61 to be connected to the output terminals (the output-side pins).

FIG. 6 shows a structure in which the upper core 20-1 of the inductor core 20 is removed from the plan view of FIG. 1. The second output-side pin 8 and the third output-side pin 9 are inserted through both ends of the inductor coil 60.

Electrical connection of the inductor coil 60 will now be described with reference to FIGS. 3 and 6. First, the lower end portion 61 (the lower terminal connection portion) of the inductor coil 60 has a first pin hole 63a formed therein, and the upper end portion 62 (the upper terminal connection portion) thereof has a second pin hole 63b formed therein.

On the basis of the plan view of FIG. 6, the first pin hole 63a is aligned with the second output terminal hole 33b and the fifth output terminal hole 43b, and the second pin hole 63b is aligned with the third output terminal hole 33c and the sixth output terminal hole 43c.

The second output-side pin 8 passes through the first pin hole 63a, the second output terminal hole 33b, and the fifth output terminal hole 43b, and the third output-side pin 9 passes through the second pin hole 63b, the third output terminal hole 33c, and the sixth output terminal hole 43c.

The inductor coil 60 is electrically connected to the secondary coil 50 disposed thereunder via the second output-side pin 8, and the third output-side pin 9 acts as an output terminal of the inductor.

FIG. 4 is an electrical symbol diagram of the inductor-integrated transformer structured as described above.

In FIG. 4, numerals 1, 5, 6, 8, and 9 respectively correspond to the reference numerals of the input-side pins 1 and 5 and the output-side pins 6, 8, and 9 described above.

In the embodiment, since the primary coil is implemented as two PCBs, i.e. the first PCB 30 and the second PCB 40, each of which has a conductive pattern forming 19 turns, the primary coil has a total of 38 turns. The secondary coil 50 is implemented as a coil formed by winding a flat wire to form 6 turns, and the inductor coil 60 is implemented as a coil formed by winding a flat wire to form 20 turns.

In the embodiment, referring to FIG. 5, a shortest distance Y from the first input-side pin 1 and the second input-side pin 5 to the first surface 12 of the transformer core 10 and a shortest distance X from the first output-side pin 6, the second output-side pin 8, and the third output-side pin 9 to the second surface 13 of the transformer core 10 have the following relationship.

X×1.2≤Y≤X×1.5

When the distance Y is less than 1.2 times the distance X, parasitic capacitance increases due to reduction in the distance between the transformer and the inductor, and when the distance Y is greater than 1.5 times the distance X, the impact strength of the coil decreases, and coil loss increases due to increase in direct current resistance (DCR), as shown in the equation below.

Meanwhile, in the embodiment, since the first input-side pin 1, which is the input terminal, is inserted into the first input terminal hole 32a formed in the protruding portion 34, an insulation distance between the primary power supply (e.g. the high-voltage-battery-side power supply) and the transformer core 12 additionally increases. The embodiment exhibits an effect of increase by 40% on the basis of the first input-side pin 1.

DCR=ρ×l/A→P=I2×DCR

(where DCR: direct current resistance, ρ: specific resistance, l: length, A: area, P: coil loss power, I: current)

In addition, in the embodiment, referring to FIG. 6, a shortest distance L from the wound portion 61 of the inductor coil 60 to the first pin hole 63a or the second pin hole 63b and a line width M of the wound portion 61 of the inductor coil 60 have the following relationship. In this case, the wound portion 61 may be defined as an imaginary circle formed by overlapping between the flat wire forming a plurality of turns and the inductor core in the thickness direction.

M×0.4≤L≤M×0.6

When the distance L is less than 0.4 times the line width M, heat generation increases due to increase in current density, and process defects (e.g. soldering defects) increase. When the distance L is greater than 0.6 times the line width M, it becomes difficult to ensure flatness and to assemble components, and resistance characteristics deteriorate.

Meanwhile, FIG. 8 shows a structure in which a metal ribbon is applied to the embodiment of the present disclosure. As shown, the transformer core 10 is surrounded by a first metal ribbon 70, and the inductor core 20 is surrounded by a second metal ribbon 80.

The first metal ribbon 70 and the second metal ribbon 80 serve to respectively expand paths for lines of magnetic force of the transformer core 10 and the inductor core 20.

The first metal ribbon 70 surrounds the transformer core 10 so as to cover the outer peripheral surface of the transformer core 10 between the front surface 12 and the rear surface 13, each of which has an opening.

The second metal ribbon 80 surrounds the inductor core 20 so as to cover the outer peripheral surface of the inductor core 10 between the front surface 22 and the rear surface 23, each of which has an opening.

Further, the first metal ribbon 70 and the second metal ribbon 80 are preferably made of an Fe—Si-based amorphous or crystalline alloy.

FIG. 9 is a graph comparing saturation magnetic flux densities between the metal ribbon and ferrite. As shown in the drawing, it can be seen that the saturation magnetic flux density of the metal ribbon is much higher than that of ferrite.

Each of the first metal ribbon 70 and the second metal ribbon 80 preferably has a thickness of 20 to 30 μm, and a difference between the width of each of the first metal ribbon 70 and the second metal ribbon 80 and the width of a corresponding one of the transformer core 10 and the inductor core 20 in the forward-backward direction (a distance between the front surface 12 or 22 and the rear surface 13 or 23) may be within a range of about t5% of the width of the core.

In addition, it is preferable that the number of layers in which each of the metal ribbons 70 and 80 surrounds a corresponding one of the cores 10 and 20 be 3 or greater, as shown in FIG. 8.

Comparison between change in the inductance of the transformer in the state in which the metal ribbons 70 and 80 are applied thereto as described above and change in the inductance of the transformer before the metal ribbons 70 and 80 are applied thereto is shown in FIG. 10. Similarly, comparison of changes in the inductance of the inductor between after and before application of the metal ribbons 70 and 80 is shown in FIG. 11.

As shown in FIGS. 10 and 11, it can be seen that, when the metal ribbons 70 and 80 are applied as shown in FIG. 8, the inductance of the transformer and the inductance of the inductor increase compared to when the metal ribbons 70 and 80 are not applied.

Accordingly, when the transformer and the inductor are applied to a back-up unit, UVP decreases, and OCP increases due to increase in the inductance.

Table 1 shows inductance, heat generation temperature, OCP, and UVP measured in the embodiment of the present disclosure, comparative example 1, and comparative example 2.

### EMBODIMENT

Case in which the transformer and the inductor are respectively surrounded by the first metal ribbon 70 and the second metal ribbon 80.

### Comparative Example 1

Case in which no metal ribbon is applied.

### Comparative Example 2

Case in which a transformer and an inductor are not respectively surrounded by individual metal ribbons, but an assembly in which the inductor is seated on the transformer is surrounded by a single metal ribbon.

TABLE 1

| | | | | Comparative | Comparative |
|---|---|---|---|---|---|
| Specification | | | Embodiment | Example 1 | Example 2 |
| Inductance | Primary | @ OA | 1,021 | 991 | 991 |
| (μH) | Transformer | 100 kHz | | | |
| | | @ 1.8 A | 200 | 170 | 170 |
| | | 100 kHz | | | |
| | Inductor | @ OA | 44 | 40 | 40 |
| | | 100 kHz | | | |
| | | @ OA | 22 | 19 | 19 |
| | | 100 kHz | | | |

| Heat Generation | Transformer | 105 | | 110 | | 103 | |
|---|---|---|---|---|---|---|---|
| Temperature (° C.) | Inductor | 115 | | 120 | | 110 | |
| OCP (Ampere) | Max. | 16 | A | 14 | A | 14 | A |
| | 16 A | | | | | | |
| UVP (Volt) | Min. | 5.3 | V | 6.5 | V | 6.5 | V |

5.6 V

As shown in Table 1, in the embodiment, inductance increases, and heat generation temperature is approximately similar compared to the comparative examples. In particular, OCP increases, and UVP decreases.

Consequently, it is confirmed that the embodiment of the present disclosure exhibits an effect of increasing OCP and reducing UVP.

Hereinafter, effects according to the number of layers of each of the metal ribbons 70 and 80 will be described.

First, considering the following relationship, as the number of layers decreases, permeability increases in order to obtain given inductance (refer to Table 2). Thus, as applied current increases, inductance (permeability) greatly decreases. Therefore, it is possible to realize 4 pH or more at 16 A when the number of layers is 3 or greater.

$$L = \frac{{μ}_{r} \cdot Ae \cdot {N}^{2}}{{l}_{e}}$$

(L: inductance, r: permeability, Ae: cross-sectional area, le: length of magnetic mean path, N: number of coil turns)

TABLE 2

| Inductance | 1 Layer | 2 Layer | 3 Layer |
|---|---|---|---|
| L₀ (0 A) | 6 μH | | |
| L_{DC} (16 A) | 1.2 | 2.4 | 4.5 |
| Permeability | 1,180 | 590 | 393 |

FIG. 12 shows permeability according to the number of layers.

Meanwhile, the width of each of the metal ribbons 70 and 80, i.e. an application range of each of the metal ribbons 70 and 80 with respect to the width of a respective one of the cores 10 and 20 in the forward-backward direction, will be described.

As can be seen from the above relationship, inductance is proportional to permeability, a cross-sectional area, and a square of the number of coil turns.

In addition, considering the following relationship, when the application cross-sectional area of each of the metal ribbons 70 and 80 is constant, as the length le of the magnetic mean path decreases, i.e. as the application area decreases, the value of magnetizing force H increases, and thus permeability (inductance) decreases. That is, effects deteriorate

$$L = \frac{H \cdot I}{{l}_{e}} \cdot ( H ∝ I )$$

(H: magnetizing force [Oe], I: current [A], N: number of coil turns)

FIG. 13 is a graph showing a permeability difference according to the application range of each of the metal ribbons 70 and 80.

In FIG. 13, “Exterior of Center Leg (Cylinder)” represents a case in which the metal ribbon 70 or 80 having a width equivalent to that of the center leg 11 and 21 is wound on a center portion of the width of the core 10 or 20 in the forward-backward direction [Case (1)], “Exterior of Inductor (Excluding Lower Portion)” represents a case in which the metal ribbon is applied to the entirety of the width in the forward-backward direction but no metal ribbon is applied to the lower surface of the inductor core 20 or the upper surface of the transformer core 10 like comparative example 2 [Case (2)], and “Whole Exterior of Inductor” represents a case in which the metal ribbon is applied to the entirety of the width in the forward-backward direction and is also applied to the lower surface of the inductor core 20 and the upper surface of the transformer core 10 like the embodiment [Case (3)]. Here, a difference between the width of each of the first metal ribbon 70 and the second metal ribbon 80 and the width of a corresponding one of the cores 10 and 20 in the forward-backward direction may be set to fall within a range of about +5% of the width of the core.

The magnetic mean path, the magnetizing force, and a drop rate of the inductance in each of the cases of FIG. 13 are shown in Table 3 below.

TABLE 3

| | | Exterior of Inductor | |
|---|---|---|---|
| Ribbon-Wounded | Exterior of Center | (Excluding Lower | Whole Exterior of |
| Region | Leg (Cylinder)⁽¹⁾ | Portion)⁽²⁾ | Inductor⁽³⁾ |
| Magnetic Mean Path | 34.5 | 48.0 | 63.5 |
| H (@ 16 A) | 175 Oe | 125 Oe | 95 Oe |
| Drop Rate (%) | 25% (4.5 μH | 31% (4.0 μH | 45% (3.3 μH |
| | Maintained) | Maintained) | Maintained) |

It will be apparent to those skilled in the art that various changes in form and details may be made without departing from the spirit and essential characteristics of the disclosure set forth herein. Accordingly, the above detailed description is not intended to be construed to limit the disclosure in all aspects and to be considered by way of example. The scope of the disclosure should be determined by reasonable interpretation of the appended claims and all equivalent modifications made without departing from the disclosure should be included in the following claims.

### MODE FOR INVENTION

Various embodiments have been described in the best mode for carrying out the disclosure.

1. An inductor-integrated transformer, comprising:
a transformer core comprising an upper core and a lower core;
a transformer coil comprising a primary coil and a secondary coil, the primary coil and the secondary coil being disposed inside the transformer core;
an inductor core disposed on the transformer core, the inductor core comprising an upper core and a lower core; and
an inductor coil disposed inside the inductor core,
wherein the primary coil comprises:
a plurality of input terminals spaced apart from a first surface of the transformer core by a first distance (Y); and
a plurality of output terminals spaced apart from a second surface of the transformer core by a second distance (X), the second surface being a surface opposite the first surface, and
wherein the output terminals are conductively connected to the secondary coil and the inductor coil, and the first distance (Y) is greater than the second distance (X).

2. The inductor-integrated transformer according to claim 1, wherein the first distance (Y) and the second distance (X) have one of following relationships:
(a) the first distance (Y) being greater than or equal to 1.2 times the second distance (X);
(b) the first distance (Y) being less than or equal to 1.5 times the second distance (X); and
(c) the first distance (Y) being within a range of 1.2 times to 1.5 times the second distance (X).

3. The inductor-integrated transformer according to claim 1, wherein the transformer core comprises a first center leg,
wherein the primary coil comprises:
a coil portion formed so as to surround the first center leg;
a first extended portion extending from the coil portion to an exterior of the first surface, the first extended portion having a plurality of input terminal holes formed therein corresponding to the plurality of input terminals; and
a second extended portion extending from the coil portion to an exterior of the second surface, the second extended portion having a plurality of output terminal holes formed therein corresponding to the plurality of output terminals,
wherein each of the input terminals comprises an input-side pin inserted into a corresponding one of the input terminal holes, and
wherein each of the output terminals comprises an output-side pin inserted into a corresponding one of the output terminal holes.

4. The inductor-integrated transformer according to claim 1, wherein the inductor core comprises a second center leg,
wherein the inductor coil comprises:
a wound portion wound so as to surround the second center leg; and
a terminal connection portion extending from both ends of the wound portion to be connected to the output terminals, and
wherein a shortest distance (L) from the wound portion to the output terminals and a line width (M) of the wound portion of the inductor coil have one of following relationships:
(a) the shortest distance (L) being greater than or equal to 0.4 times the line width (M);
(b) the shortest distance (L) being less than or equal to 0.6 times the line width (M); and
(c) the shortest distance (L) being within a range of 0.4 times to 0.6 times the line width (M).

5. The inductor-integrated transformer according to claim 3, wherein the primary coil comprises an upper primary coil and a lower primary coil, the upper primary coil and the lower primary coil being vertically spaced apart from each other, and
wherein the secondary coil is disposed between the upper primary coil and the lower primary coil.

6. An inductor-integrated transformer, comprising:
a transformer; and
an inductor disposed on the transformer,
wherein the transformer comprises:
a transformer core comprising an upper core and a lower core; and
a primary coil and a secondary coil disposed inside the transformer core,
wherein the inductor comprises:
an inductor core comprising an upper core and a lower core; and
an inductor coil, and
wherein the inductor-integrated transformer comprises a metal ribbon disposed on an outer surface of each of the transformer core and the inductor core.

7. The inductor-integrated transformer according to claim 6, wherein the metal ribbon comprises:
a first metal ribbon surrounding the transformer core; and
a second metal ribbon surrounding the inductor core.

8. The inductor-integrated transformer according to claim 6, wherein each of the transformer core and the inductor core has an opening formed in each of a front surface and a rear surface thereof,
wherein the primary coil is electrically connected to an input unit through the opening formed in the front surface of the transformer core,
wherein the secondary coil is electrically connected to an output unit through the opening formed in the rear surface of the transformer core, and
wherein the inductor coil is electrically connected to the output unit through the opening formed in the rear surface of the inductor core.

9. The inductor-integrated transformer according to claim 8, wherein the outer surface is a surface formed between the front surface and the rear surface of each of the transformer core and the inductor core.

10. The inductor-integrated transformer according to claim 9, wherein a width of the metal ribbon is within a range of 5% of a distance between the front surface and the rear surface of each of the transformer core and the inductor core.

11. The inductor-integrated transformer according to claim 3, wherein the first extended portion includes a protruding portion protruding therefrom in a direction intersecting the direction in which the first extended portion extends from the coil portion, and
wherein at least one of the plurality of input terminal holes is disposed in the protruding portion.

12. The inductor-integrated transformer according to claim 5, wherein each of the secondary coil and the inductor coil is formed by winding a flat wire.

13. The inductor-integrated transformer according to claim 5, wherein at least one of the upper primary coil or the lower primary coil is a printed circuit board (PCB).

14. The inductor-integrated transformer according to claim 13, wherein the upper primary coil and the lower primary coil have shapes corresponding to each other.

15. The inductor-integrated transformer according to claim 6, wherein the metal ribbon surrounds each core in three layers or more.

16. The inductor-integrated transformer according to claim 6, wherein the metal ribbon has a higher saturation magnetic flux density than each of the transformer core and the inductor core.

17. The inductor-integrated transformer according to claim 6, wherein the metal ribbon includes a material of Fe—Si.

18. The inductor-integrated transformer according to claim 9, wherein the metal ribbon completely surrounds the outer surface.

19. An inductor-integrated transformer, comprising:
a transformer core comprising an upper core and a lower core;
a transformer coil comprising a primary coil and a secondary coil, the primary coil and the secondary coil being disposed inside the transformer core;
an inductor core disposed on the transformer core, the inductor core comprising an upper core and a lower core; and
an inductor coil disposed inside the inductor core,
wherein each of the transformer core and the inductor core has an opening formed in each of a front surface and a rear surface thereof,
wherein the primary coil is electrically connected to an input unit through the opening formed in the front surface of the transformer core,
wherein the secondary coil is electrically connected to an output unit through the opening formed in the rear surface of the transformer core, and
wherein the inductor coil is electrically connected to the output unit through the opening formed in the rear surface of the inductor core.

20. The inductor-integrated transformer according to claim 19, wherein the primary coil comprises an upper primary coil and a lower primary coil, the upper primary coil and the lower primary coil being vertically spaced apart from each other, and
wherein the secondary coil is disposed between the upper primary coil and the lower primary coil.
